(19) United States
(12) Patent Application Publication
(10) Pub. No.: US 2017/0083955 A1
(43) Pub. Date: Mar. 23, 2017

(54) License Givebacks in a Rate-Based System

(71) Applicant: International Business Machines Corporation, Armonk, NY (US)

(72) Inventors: Gregory A. Davis, New Brunswick (CA); Colin Labron, Staffordshire (GB)

(21) Appl. No.: 14/858,516

(22) Filed: Sep. 18, 2015

(51) Int. Cl. G06Q 30/02

(52) U.S. Cl. CPC G06Q 30/0283

(57) ABSTRACT

A method, system and computer-usable medium are disclosed for managing a rate-based license, comprising: executing a plurality of events on a security platform, the executing being based upon a rate-based license between a licensee and a security platform provider; analyzing the plurality of events to identify any of the plurality of the events not covered by license terms of the rate-based license; and, performing a license giveback operation to provide the licensee with an event credit for events not covered by the license terms.

### BACKGROUND OF THE INVENTION

Field of the Invention

The present invention relates in general to the field of computers and similar technologies, and in particular to software utilized in this field. Still more particularly, it relates to a method, system and computer-usable medium for managing a rate-based license.

Description of the Related Art

Organizations today are exposed to a greater volume and variety of attacks than in the past. Advanced attackers are clever and patient, leaving just a whisper of their presence. Accordingly, it is desirable to provide security functionality which helps to detect and defend against threats by applying sophisticated analytics to more types of data. It is also desirable to provide such security functionality which identifies high-priority incidents that might otherwise get lost in the noise of the overall operation of a large scale information processing environment.

It is known to provide security functionality to IT environments via security intelligence platforms which integrate security information and event management (SIEM), log management, anomaly detection, vulnerability management, risk management and incident forensics into a unified solution. One issue associated with large scale IT platforms such as security intelligence platforms relates to license maintenance and accounting. With certain large scale security systems, licenses are based upon a number of events using the system over a certain amount of time. In these systems a large number of license events can occur within a relatively short amount of time (e.g., thousands of license events per second) where some of these detected events may not necessarily fall under the license terms. For example, certain internal operations may be logged as license events.

### SUMMARY OF THE INVENTION

A method, system and computer-usable medium are disclosed for managing a rate-based license, comprising: executing a plurality of events on a security platform, the executing being based upon a rate-based license between a licensee and a security platform provider; analyzing the plurality of events to identify any of the plurality of the events not covered by license terms of the rate-based license; and, performing a license giveback operation to provide the licensee with an event credit for events not covered by the license terms.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary computer in which the present invention may be implemented.

FIG. 2 is a simplified block diagram of a security intelligence platform.

FIG. 3 is a generalized flowchart of a license give back operation.

### DETAILED DESCRIPTION

A method, system and computer-usable medium are disclosed for performing rate based license maintenance and accounting operations to address when certain detected events do not fall under certain license terms. More specifically, in various embodiments, the rate based license maintenance and accounting operation comprises a license giveback operation to account for where some detected events may not necessarily fall under the license terms of a system executing license events based upon rate based licenses.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

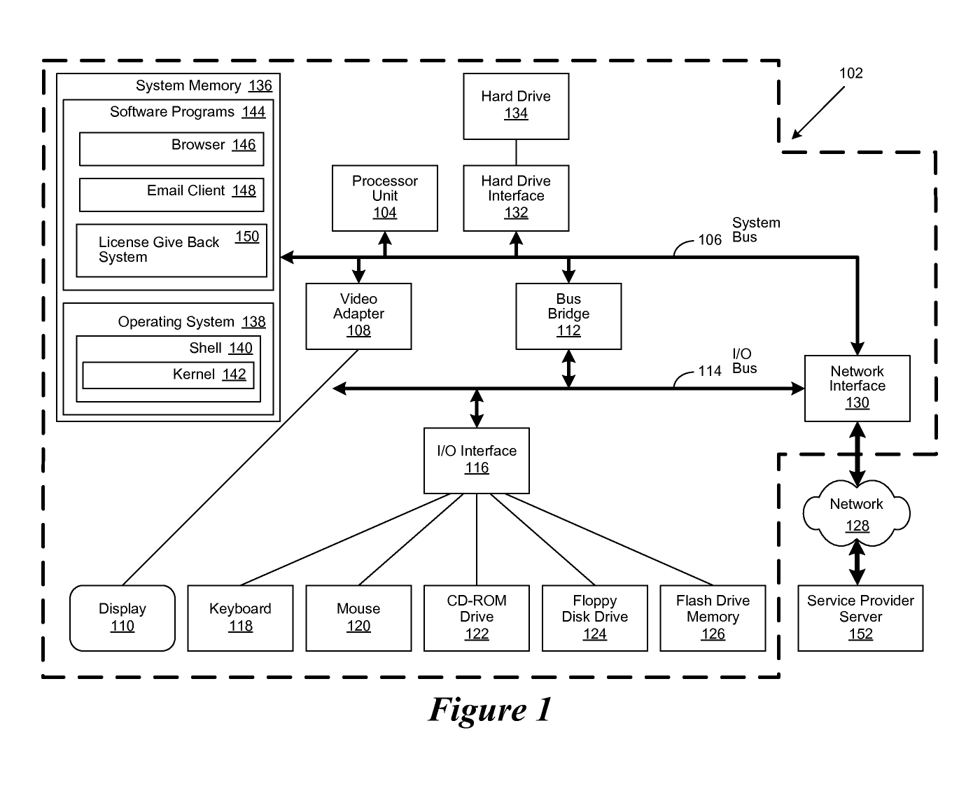

FIG. 1 is a block diagram of an exemplary computer 102 in which the present invention may be utilized. Computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 may include a browser 146 and email client 148. Browser 146 includes program modules and instructions enabling a World Wide Web (WWW) client (i.e., computer 102) to send and receive network messages to the Internet using HyperText Transfer Protocol (HTTP) messaging, thus enabling communication with service provider server 152. In various embodiments, software programs 144 may also include license give back system 150. In these and other embodiments, the license give back system 150 includes code for implementing the processes described hereinbelow. In one embodiment, computer 102 is able to download the license give back system 150 from a service provider server 152.

The hardware elements depicted in computer 102 are not intended to be exhaustive, but rather are representative to highlight components used by the present invention. For instance, computer 102 may include alternate memory storage devices such as magnetic cassettes, Digital Versatile Disks (DVDs), Bernoulli cartridges, and the like. These and other variations are intended to be within the spirit, scope and intent of the present invention.

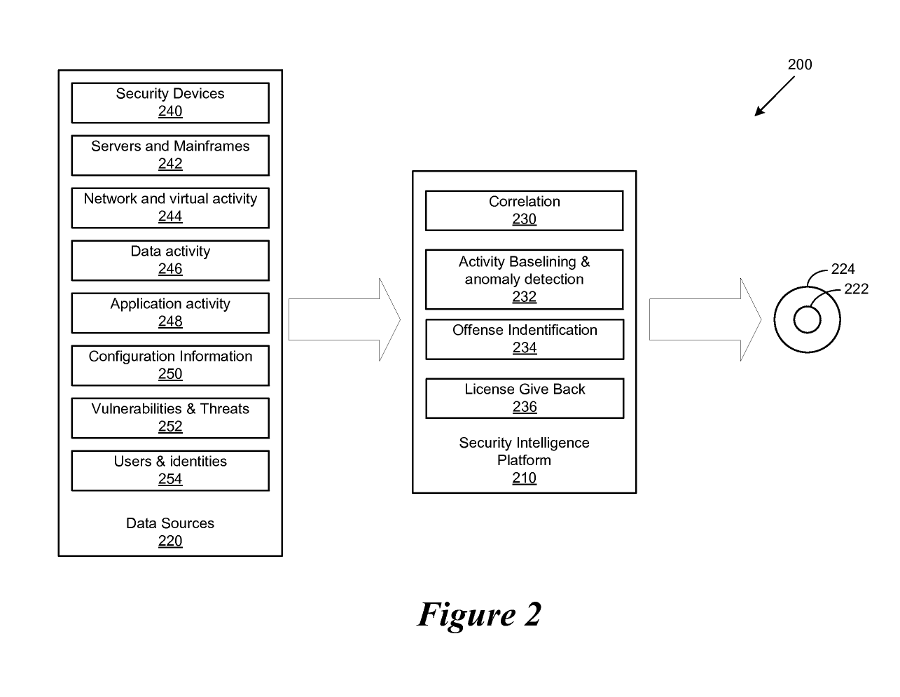

FIG. 2 shows a simplified block diagram of a security intelligence environment 200 which includes a security intelligence platform 210 in accordance with various aspects of the invention. The security intelligence platform 210 integrates security information and event management (SIEM), log management, anomaly detection, vulnerability management, risk management and incident forensics into a unified solution. By using intelligence, integration and automation to provide 360-degree security insight, the security intelligence platform 210 delivers threat detection, ease of use and lower total cost of ownership. The security intelligence platform 210 uses intelligence, integration and automation to deliver security and compliance functionality.

The security intelligence platform 210 receives information from one or more of a plurality of data sources 220 and performs one or more of correlation operations, activity baselining and anomaly detection operations, offense identification operations to provide an identification of a true offense 222 as well as identification of suspected intendents 224 as well as a license give back operation. In certain embodiments, the security intelligence platform 210 includes one or more of an integrated family of modules that can help detect threats that otherwise would be missed. For example, in certain embodiments, the family of modules can include a correlation module 230 for performing the correlation operations, an activity baselining and anomaly detection module 232 for performing the activity baselining and anomaly detection operations, an offence identification module 234 for performing the offence identification operation and a license give back module 236 for performing the license give back operation. In various embodiments, the license give back system 150 performs one or more of the functions of the license give back module 236.

In various embodiments, the correlation operation includes one or more of logs/events analysis, flow analysis, IP reputation analysis and geographic location analysis. In various embodiments, the activity baselining and anomaly detection operation includes one or more of user activity analysis, database activity analysis, application activity analysis and network activity analysis. In various embodiments, the offense identification operation includes one or more of credibility analysis, severity analysis and relevance analysis. In various embodiments, license give back operation accounts for where some detected events may not necessarily fall under license terms of the security intelligence platform 210.

The plurality of data sources 220 can include one or more of security devices 240, servers and mainframes 242, network and virtual activity data sources 244, data activity data sources 246, application activity data sources 248, configuration information data sources 250, vulnerabilities and threats information data sources 252 as well as users and identities data sources 254.

The security intelligence platform 210 helps detect and defend against threats by applying sophisticated analytics to the data received from the plurality of data sources. In doing so, the security intelligence platform 210 helps identify high-priority incidents that might otherwise get lost in the noise of the operation of a large scale information processing environment. The security intelligence platform 200 uses some or all of the integrated family of modules to solve a number of business issues including:

consolidating data silos into one integrated solution; identifying insider theft and fraud; managing vulnerabilities, configurations, compliance and risks; conducting forensic investigations of incidents and offenses; and, addressing regulatory mandates.

In various embodiments, the security intelligence platform 210 provides a plurality of functions. For example, in certain embodiments, the security intelligence platforms consolidates data silos from a plurality of data sources. More specifically, while a wealth of information exists within organizations operating large scale information processing systems such as log, network flow and business process data, this information is often held in discrete data silos. The security intelligence platform 210 converges network, security and operations views into a unified and flexible solution. The security intelligence platform breaks down the walls between silos by correlating logs with network flows and a multitude of other data, presenting virtually all relevant information on a single screen. Such a correlation helps enable superior threat detection and a much richer view of enterprise activity.

Additionally, in various embodiments, the security intelligence platform performs an insider fraud detection operation. Some of the gravest threats to an organization can come from the inside the organization, yet organizations often lack the intelligence needed to detect malicious insiders or outside parties that have compromised user accounts. By combining user and application monitoring with application-layer network visibility, organizations can better detect meaningful deviations from normal activity, helping to stop an attack before it completes.

Additionally, in various embodiments, the security intelligence platform 210 predicts and remediates risk and vulnerabilities. Security, network and infrastructure teams strive to manage risk by identifying vulnerabilities and prioritizing remediation before a breach occurs. The security intelligence platform 210 integrates risk, configuration and vulnerability management with SIEM capabilities, including correlation and network flow analytics, to help provide better insight into critical vulnerabilities. As a result, organizations can remediate risks more effectively and efficiently.

Additionally, in various embodiments, the security intelligence platform 210 can conduct forensics analysis. In certain embodiments, the security intelligence platform 210 includes integrated incident forensics helps IT security teams reduce the time spent investigating security incidents, and eliminates the need for specialized training. The security intelligence platform 210 expands security data searches to include full packet captures and digitally stored text, voice, and image documents. The security intelligence platform helps present clarity around what happened when, who was involved, and what data was accessed or transferred in a security incident. As a result, the security intelligence platform 210 helps remediate a network breach and can help prevent it from succeeding again.

Additionally, in various embodiments, the security intelligence platform 210 addresses regulatory compliance mandates. Many organizations wrestle with passing compliance audits while having to perform data collection, monitoring and reporting with increasingly limited resources. To automate and simplify compliance tasks, the security intelligence platform 210 provides collection, correlation and reporting on compliance-related activity, backed by numerous out-of-the-box report templates.

The security intelligence platform 210 leverages easier-to-use security analytics. More specifically, the security intelligence platform 210 provides a unified architecture for storing, correlating, querying and reporting on log, flow, vulnerability, and malevolent user and asset data. The security intelligence platform 210 combines sophisticated analytics with out-of-the-box rules, reports and dashboards. While the platform is powerful and scalable for large corporations and major government agencies, the platform is also intuitive and flexible enough for small and midsize organizations. Users benefit from potentially faster time to value, lower cost of ownership, greater agility, and enhanced protection against security and compliance risks.

The security intelligence platform 210 provides advanced intelligence. More specifically, by analyzing more types of data and using more analytics techniques, the platform can often detect threats that might be missed by other solutions and help provide advanced network visibility.

The security intelligence platform 210 also provides advanced integration. Because the security intelligence platform includes a common application platform, database and user interface, the platform delivers massive log management scale without compromising the real-time intelligence of SIEM and network behavior analytics. It provides a common solution for all searching, correlation, anomaly detection and reporting functions. A single, intuitive user interface provides seamless access to all log management, flow analysis, incident management, configuration management, risk and vulnerability management, incident forensics, dashboard and reporting functions.

The security intelligence platform 210 also provides advanced automation. More specifically, the security intelligence platform 201 is simple to deploy and manage, offering extensive out-of-the-box integration modules and security intelligence content. By automating many asset discovery, data normalization and tuning functions, while providing out-of-the-box rules and reports, the security intelligence platform 210 is designed to reduce complexity of the operation of the platform.

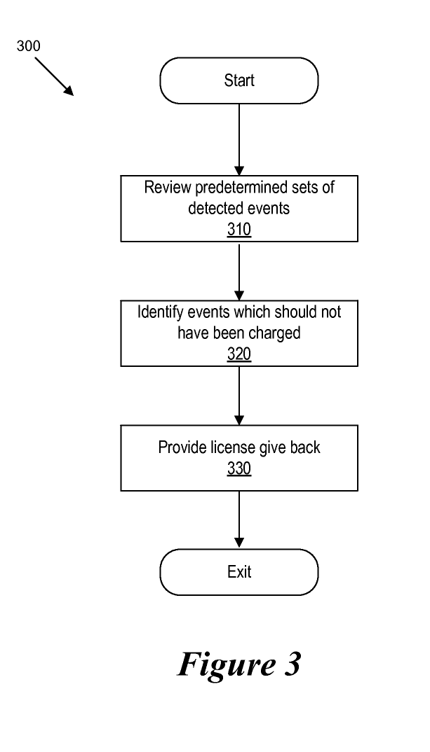

FIG. 3 is a flow chart of a license give back operation 300 in accordance with aspects of the present disclosure. The license give back operation 300 is especially beneficial for systems such as the security intelligence platform 210 which executes license events based upon rate based licenses. The license give back operation accounts for where some of these detected events may not necessarily fall under the license terms. More specifically, the license give back operation begins operation at step 310 with the license give back module 234 reviewing predetermined sets of detected events. Next at step 320, the license give back module 234 identifies any events which should not be charged against a customer's license. In certain embodiments internally generated events as well as events chosen by the user to be noise (i.e., not important) may correspond to events which should not be charged against the customer's license. Internally generated events are given back at a 1:1 ratio and anything a customer chooses to drop or ignore is given back at a configurable percentage and maximum (configurable is determined by the security intelligence platform provider). Additionally, in certain embodiments, the identifying events which should not be charged against a customer's license includes applying a rate based license analysis to the events. Additionally, in certain embodiments, the identifying events which should not be charged against a customer's license includes parsing data associated with each event into a normalized form to facilitate the identification. Next, at step 330, for these identified events, the license give back module 234 provides a license giveback. In certain embodiments, the license give back provides a customer's license with a credit for the events which should not have been charged. Additionally, in certain embodiments, the license giveback operation further includes a correlation analysis of the events causing the license giveback so that the security intelligence platform can minimize such license charges during future operations.

The review of the predetermined sets of detected events may apply some form of statistical analysis to identify any events which should not be charged against a customer's license. In certain embodiments, the statistical analysis corresponds to a determination of a percentage of events that the customer chooses to be junk (i.e., not important to analyze) and the absolute maximum percentage of detected events. Additionally, the review for a certain amount of time may be extrapolated across longer amounts of time. In certain embodiments, the security intelligence platform uses a license which is time-based and the security intelligence platform includes an ability of measuring events included within the amount of time defined by the time-based license. For instance, certain time-based licensing is based on events per second. However, the security intelligence platform can adjust the time over which the license is applied. For example, 1000 events per second can be reviewed (i.e., audited) once every 5 seconds, which is 5000 events. Thus, if a customer is experiencing bursty (i.e., uneven) event rates, such an extrapolation can help even the hits to the license. Additionally, the license giveback operation may include a decay function where the credited events decay over a certain amount of time. By providing a decay function, the credited events are prevented from accumulating infinitely. Additionally, such a decay function protects the information pipeline to ensure that events are not dropped or lost due to exhaustion of resources

The system may also include a feedback loop which provides information regarding the events which should not have been charged to prevent the charge in future time blocks.

Although the present invention has been described in detail, it should be understood that various changes, substitutions and alterations can be made hereto without departing from the spirit and scope of the invention as defined by the appended claims.

1-6. (canceled)

7. A system comprising:
a processor;
a data bus coupled to the processor; and
a computer-usable medium embodying computer program code, the computer-usable medium being coupled to the data bus, the computer program code used for managing a rate-based license and comprising instructions executable by the processor and configured for:
executing a plurality of events on a security platform, the executing being based upon a rate-based license between a licensee and a security platform provider;
analyzing the plurality of events to identify any of the plurality of the events not covered by license terms of the rate-based license;
performing a license giveback operation to provide the licensee with an event credit for events not covered by the license terms.

8. The system of claim 7, wherein:
the analyzing the plurality of events further comprises reviewing the predetermined sets of detected events.

9. The system of claim 8, wherein:
the predetermine sets of detected events are identified by applying a statistical analysis operation to identify any events which should not be charged against the rate-based license.

10. The system of claim 7, wherein:
the analyzing the plurality of events occurs over a certain amount of time, the analyzing then being extrapolated across longer amounts of time.

11. The system of claim 7, wherein:
the license giveback operation comprises a decay function where credited events decay over a certain amount of time.

12. The system of claim 7, wherein:
the license giveback operation comprises a configurable decay percentage per a configurable license interval.

13. A non-transitory, computer-readable storage medium embodying computer program code, the computer program code comprising computer executable instructions configured for:
executing a plurality of events on a security platform, the executing being based upon a rate-based license between a licensee and a security platform provider;
analyzing the plurality of events to identify any of the plurality of the events not covered by license terms of the rate-based license;
performing a license giveback operation to provide the licensee with an event credit for events not covered by the license terms.

14. The non-transitory, computer-readable storage medium of claim 13, wherein:
the analyzing the plurality of events further comprises reviewing the predetermined sets of detected events.

15. The non-transitory, computer-readable storage medium of claim 14, wherein:
the predetermine sets of detected events are identified by applying a statistical analysis operation to identify any events which should not be charged against the rate-based license.

16. The non-transitory, computer-readable storage medium of claim 13, wherein:
the analyzing the plurality of events occurs over a certain amount of time, the analyzing then being extrapolated across longer amounts of time.

17. The non-transitory, computer-readable storage medium of claim 13, wherein:
the license giveback operation comprises a decay function where credited events decay over a certain amount of time.

18. The non-transitory, computer-readable storage medium of claim 13, wherein:
the license giveback operation comprises a configurable decay percentage per a configurable license interval.

19. The non-transitory, computer-readable storage medium of claim 13, wherein the computer executable instructions are deployable to a client system from a server system at a remote location.

20. The non-transitory, computer-readable storage medium of claim 13, wherein the computer executable instructions are provided by a service provider to a user on an on-demand basis.
